(19) United States
(12) Patent Application Publication
(10) Pub. No.: US 2024/0145704 A1
(43) Pub. Date: May 2, 2024

(54) POSITIVE ELECTRODE MATERIAL AND BATTERY

(71) Applicant: Panasonic Intellectual Property Management Co., Ltd., Osaka (JP)

(72) Inventors: Yumi MIYAMOTO, Osaka (JP); Masahisa FUJIMOTO, Osaka (JP)

(21) Appl. No.: 18/407,885

(22) Filed: Jan. 9, 2024

Related U.S. Application Data
(63) Continuation of application No. PCT/JP2022/026127, filed on Jun. 29, 2022.

(30) Foreign Application Priority Data
Jul. 16, 2021 (JP) 2021-118206

(51) Int. Cl. H01M 4/525; H01M 4/02; H01M 4/505; H01M 10/052; H01M 10/0562

(52) U.S. Cl. CPC H01M 4/525; H01M 4/505; H01M 10/052; H01M 10/0562; H01M 2004/028; H01M 2300/0071; H01M 2300/008

(57) ABSTRACT

A positive electrode material of the present disclosure includes: a positive electrode active material; and a first solid electrolyte material coating at least a portion of a surface of the positive electrode active material. The positive electrode active material includes a Li-including transition metal oxide. The first solid electrolyte material includes Li, P, O, and F.

This application is a continuation of PCT/JP2022/026127 filed on Jun. 29, 2022, which claims foreign priority of Japanese Patent Application No. 2021-118206 filed on Jul. 16, 2021, the entire contents of both of which are incorporated herein by reference.

### BACKGROUND OF THE INVENTION

### 1. Field of the Invention

The present invention relates to a positive electrode material and a battery.

### 2. Description of Related Art

WO 2019/146216 A1 discloses an all-solid-state battery including a positive electrode material in which at least a surface of a portion of a positive electrode active material including nickel, cobalt, and manganese is coated with lithium niobate.

### SUMMARY OF THE INVENTION

The present disclosure provides a technique for improving the charge and discharge capacity of a battery.

A positive electrode material of the present disclosure includes:
a positive electrode active material; and
a first solid electrolyte material coating at least a portion of a surface of the positive electrode active material, wherein
the positive electrode active material includes a Li-including transition metal oxide, and
the first solid electrolyte material includes Li, P, O, and F.

According to the present disclosure, the charge and discharge capacity of a battery can be improved.

### BRIEF DESCRIPTION OF THE DRAWINGS

FIG. 1 is a cross-sectional view schematically showing the configuration of a positive electrode material of Embodiment 1.

FIG. 2 is another cross-sectional view schematically showing the configuration of a positive electrode material.

FIG. 3 is a cross-sectional view schematically showing the configuration of a battery of Embodiment 2.

FIG. 4 is a cross-sectional view schematically showing the configuration of a battery of Embodiment 3.

### DETAILED DESCRIPTION

(Findings on which the Present Disclosure is Based)

WO 2019/146216 A1 discloses an all-solid-state battery including a positive electrode material including: a positive electrode active material including nickel, cobalt, and manganese; a coating material coating at least a portion of the surface of the positive electrode active material; and a halide solid electrolyte material. The coating material coating the surface of the positive electrode active material is a solid electrolyte material, and the solid electrolyte material is lithium niobate.

As for positive electrode materials including halide solid electrolytes, studies have been conventionally made on the resistance of such halide solid electrolytes to oxidative decomposition. Halide solid electrolytes are materials including, as an anion, a halogen element, such as fluorine (namely, F), chlorine (namely, Cl), bromine (namely, Br), or iodine (namely, I).

There is the following problem with a battery in which a positive electrode material includes a halide solid electrolyte including at least one element selected from the group consisting of chlorine, bromine, and iodine. Specifically, during charge of the battery, the halide solid electrolyte is oxidatively decomposed and the resulting oxidative decomposition product serves as a resistance layer. This increases the internal resistance of the battery during charge. It is inferred that the cause is an oxidation reaction of the at least one element selected from the group consisting of chlorine, bromine, and iodine included in the halide solid electrolyte. Here, the oxidation reaction refers to a side reaction that occurs in addition to a normal charge reaction in which lithium and electrons are extracted from a positive electrode active material included in the positive electrode material. In the side reaction, electrons are extracted even from the halide solid electrolyte including the at least one element selected from the group consisting of chlorine, bromine, and iodine, the halide solid electrolyte being in contact with the positive electrode active material. It is considered that this oxidation reaction forms, between the positive electrode active material and the halide solid electrolyte, an oxidative decomposition layer having a poor lithium-ion conductivity and serving as a high interfacial resistance in an electrode reaction of the positive electrode. This problem is more prone to occur in the case where a positive electrode active material having a potential of more than 3.9 V versus Li is used than in the case where a positive electrode active material having a potential of 3.9 V or less versus Li is used.

WO 2019/146216 A1 discloses a battery including a positive electrode layer including: a positive electrode active material coated with lithium niobate; and a halide solid electrolyte. Such coating of a positive electrode active material with a coating material can suppress formation of an oxidative decomposition layer due to a halide solid electrolyte to suppress an increase in internal resistance, thereby suppressing a decrease in the charge and discharge capacity of a battery.

The present inventors made intensive studies on a technique for suppressing a decrease in the charge and discharge capacity, the decrease being induced by oxidative decomposition of an electrolyte. As a result, the present inventors have arrived at the configuration of the present disclosure.

(Outline of One Aspect According to the Present Disclosure)

A positive electrode material according to a first aspect of the present disclosure includes:
a positive electrode active material; and
a first solid electrolyte material coating at least a portion of a surface of the positive electrode active material, wherein
the positive electrode active material includes a Li-including transition metal oxide, and
the first solid electrolyte material includes Li, P, O, and F.

In the positive electrode material according to the first aspect, at least a portion of the surface of the positive electrode active material is coated with the first solid electrolyte material. Thus, the first solid electrolyte material prevents a direct contact between the positive electrode active material and another electrolyte. Consequently, oxidative decomposition of the other electrolyte is suppressed, and thus a decrease in the charge and discharge capacity of a battery is suppressed too. In other words, the charge and discharge capacity of a battery can be enhanced. Moreover, since the first solid electrolyte material includes highly electronegative elements such as P, O, and F, the first solid electrolyte material also has an excellent oxidation resistance. As a result, the suppressing effect on a decrease in the charge and discharge capacity lasts.

In a second aspect of the present disclosure, for example, in the positive electrode material according to the first aspect, a redox potential of the positive electrode active material versus lithium metal may be 4 V or more.

The effect achieved by application of the technique of the present disclosure to a positive electrode active material having a high redox potential is particularly high.

In a third aspect of the present disclosure, for example, in the positive electrode material according to the first or second aspect, the positive electrode active material may include a material represented by the following composition formula (1):

LiNiₓMn₂₋ₓO₄ Formula (1),
where x may satisfy 0<x<2.

In a fourth aspect of the present disclosure, for example, in the positive electrode material according to the third aspect, the composition formula (1) may satisfy 0<x<1.

In a fifth aspect of the present disclosure, for example, in the positive electrode material according to the fourth aspect, the composition formula (1) may satisfy x=0.5.

Lithium nickel manganese oxide is a positive electrode active material that can achieve a high operating voltage. However, lithium nickel manganese oxide is likely to cause oxidation of another material such as an electrolyte. The effect achieved by application of the technique of the present disclosure to lithium nickel manganese oxide, as in the third to fifth aspects, is particularly high.

In a sixth aspect of the present disclosure, for example, in the positive electrode material according to the fifth aspect, the first solid electrolyte material may include a material represented by the following composition formula (2):

LiPF_{y}O_{3-0.5y} Formula (2),
where y may satisfy 0<y<6.

Since the material represented by the formula (2) has lithium-ion conductivity and an excellent oxidation resistance, the material represented by the formula (2) is suitable for the first solid electrolyte material.

In a seventh aspect of the present disclosure, for example, in the positive electrode material according to the sixth aspect, the composition formula (2) may satisfy y=2.

When y=2 is satisfied, the material represented by the formula (2) is lithium difluorophosphate. Since lithium difluorophosphate has lithium-ion conductivity and an excellent oxidation resistance, lithium difluorophosphate is suitable for the first solid electrolyte material.

In an eighth aspect of the present disclosure, for example, in the positive electrode material according to any one of the first to seventh aspects, a percentage of a mass of the first solid electrolyte material with respect to a mass of the positive electrode active material may be 0.50% or more.

In a ninth aspect of the present disclosure, for example, in the positive electrode material according to the eighth aspect, the percentage may be 1.5% or more.

The effect by the present disclosure can be sufficiently achieved by appropriately adjusting the percentage of the mass of the first solid electrolyte material with respect to the mass of the positive electrode active material.

In a tenth aspect of the present disclosure, for example, the positive electrode material according to any one of the first to ninth aspects may further include a second electrolyte material having lithium-ion conductivity.

According to the tenth aspect, oxidative decomposition of the second electrolyte material is suppressed, and thereby a decrease in the charge and discharge capacity of a battery can be suppressed.

In an eleventh aspect of the present disclosure, for example, in the positive electrode material according to the tenth aspect, the second electrolyte material may include Li, a halogen element, and at least one selected from the group consisting of metalloid elements and metal elements except Li.

Since the second electrolyte material includes the halogen element, the second electrolyte material has a relatively high oxidation resistance. Therefore, the second electrolyte material is suitable for being used in combination with a high-potential positive electrode active material such as lithium nickel manganese oxide.

In a twelfth aspect of the present disclosure, for example, in the positive electrode material according to the tenth or eleventh aspect, the second electrolyte material may include a material represented by the following composition formula (3):

Li_{α}M_{β}X_{γ}O_{δ} Formula (3), where
α, β, and γ may each be a value greater than 0,
δ may be a value equal to or greater than 0,
M may include at least one selected from the group consisting of metalloid elements and metal elements except Li, and
X may be at least one element selected from the group consisting of F, Cl, Br, and I.

In the positive electrode material according to the twelfth aspect, the ionic conductivity of the second electrolyte material can be further enhanced. That makes it possible to further reduce resistance resulting from migration of Li ions in the positive electrode material and thus more effectively suppress an increase in the internal resistance of a battery during charge.

In a thirteenth aspect of the present disclosure, for example, in the positive electrode material according to the twelfth aspect, the M may include at least one selected from the group consisting of Y and Ta.

In the positive electrode material according to the thirteenth aspect, the ionic conductivity of the second electrolyte material can be further enhanced. That makes it possible to further reduce resistance resulting from migration of Li ions in the positive electrode material and thus more effectively suppress an increase in the internal resistance of a battery during charge.

In a fourteenth aspect of the present disclosure, for example, in the positive electrode material according to the twelfth or thirteenth aspect, the composition formula (3) may satisfy 1≤α≤4, 0<β≤2, 3≤γ<7, and 0≤δ≤2.

In the positive electrode material according to the fourteenth aspect, the ionic conductivity of the second electrolyte material can be further enhanced. That makes it possible to further reduce resistance resulting from migration of Li ions in the positive electrode material and thus more effectively suppress an increase in the internal resistance of a battery during charge.

In a fifteenth aspect of the present disclosure, for example, in the positive electrode material according to any one of the tenth to fourteenth aspects, the second electrolyte material may include a sulfide solid electrolyte.

In the positive electrode material according to the fifteenth aspect, the ionic conductivity of the second electrolyte material can be further enhanced. That makes it possible to further reduce resistance resulting from migration of Li ions in the positive electrode material and thus more effectively suppress an increase in the internal resistance of a battery during charge.

In a sixteenth aspect of the present disclosure, for example, in the positive electrode material according to the fifteenth aspect, sulfide solid electrolyte may include Li₆PS₅Cl.

In the positive electrode material according to the sixteenth aspect, the ionic conductivity of the second electrolyte material can be further enhanced. That makes it possible to further reduce resistance resulting from migration of Li ions in the positive electrode material and thus more effectively suppress an increase in the internal resistance of a battery during charge.

In a seventeenth aspect of the present disclosure, for example, in the positive electrode material according to any one of the tenth to sixteenth aspects, the first solid electrolyte material may be provided between the positive electrode active material and the second electrolyte material.

In the positive electrode material according to the seventeenth aspect, since the first solid electrolyte material having a high oxidation resistance is interposed between the positive electrode active material and the second electrolyte material, oxidative decomposition of the second electrolyte material can be suppressed and thus an increase in the internal resistance of a battery during charge can be suppressed.

A battery according to an eighteenth aspect of the present disclosure includes:
a positive electrode;
a negative electrode; and
an electrolyte layer positioned between the positive electrode and the negative electrode, wherein
the positive electrode includes the positive electrode material according to any one of the first to seventeenth aspects.

According to the battery of the eighteenth aspect, a decrease in the charge and discharge capacity thereof can be suppressed.

In a nineteenth aspect of the present disclosure, for example, in the battery according to the eighteenth aspect, the electrolyte layer may include a first electrolyte layer and a second electrolyte layer, the first electrolyte layer may be in contact with the positive electrode, and the second electrolyte layer may be in contact with the negative electrode.

According to the nineteenth aspect, materials respectively suitable for the first electrolyte layer and the second electrolyte layer can be used. For example, an electrolyte having an excellent oxidation resistance can be used for the first electrolyte layer, while a material having an excellent reduction resistance can be used for the second electrolyte layer.

In a twentieth aspect of the present disclosure, for example, in the battery according to the nineteenth aspect, the first electrolyte layer may include a material having the same composition as a composition of the first solid electrolyte material.

In a twenty-first aspect of the present disclosure, for example, in the battery according to the nineteenth or twentieth aspect, the second electrolyte layer may include a material having a composition different from a composition of the first solid electrolyte material.

Embodiments of the present disclosure will be described below with reference to the drawings.

### Embodiment 1

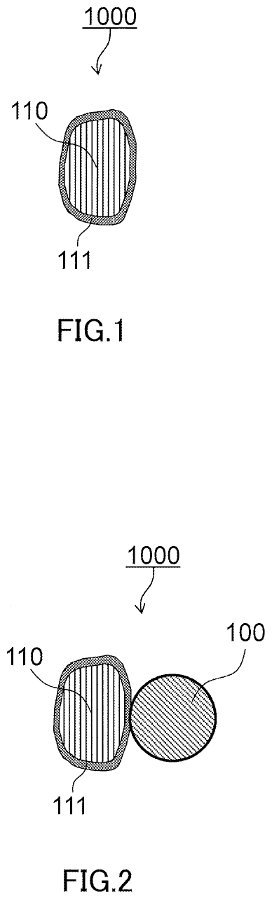

FIG. 1 is a cross-sectional view schematically showing the configuration of a positive electrode material 1000 of Embodiment 1. The positive electrode material 1000 includes a positive electrode active material 110 and a first solid electrolyte material 111 coating at least a portion of a surface of the positive electrode active material 110. The positive electrode active material includes a Li-including transition metal oxide. The first solid electrolyte material 111 includes Li, P, O, and F. The first solid electrolyte material 111 may have the shape of a coating layer coating the positive electrode active material 110.

With such a configuration, the first solid electrolyte material 111 prevents a direct contact between the positive electrode active material 110 and another electrolyte material. Consequently, oxidative decomposition of the other electrolyte material such as a later-described second electrolyte material 100 is suppressed, and thus a decrease in the charge and discharge capacity of a battery is also suppressed. Moreover, since the first solid electrolyte material 111 includes highly electronegative elements such as P, O, and F, the first solid electrolyte material 111 also has an excellent oxidation resistance. Because of this, the suppressing effect on a decrease in the charge and discharge capacity lasts.

In the positive electrode material 1000, a redox potential of the positive electrode active material 110 versus lithium metal is, for example, 4 V or more. The positive electrode active material 110 is coated with the first solid electrolyte material 111. This makes it possible to suppress oxidative decomposition of the later-described second electrolyte material 100 even when the positive electrode active material 110 having a redox potential of 4 V or more versus lithium metal is used. Consequently, a decrease in the charge and discharge capacity of a battery can be suppressed. A battery having an operating voltage of 4 V or more can be formed using the positive electrode active material 110. The effect achieved by application of the technique of the present disclosure to the positive electrode active material 110 having a high redox potential is particularly high.

The positive electrode active material 110 may include a material represented by the following composition formula (1):

LiNiₓMn₂₋ₓO₄ Formula (1),
where x satisfies 0<x<2.

The composition formula (1) may satisfy 0<x<1.

The composition formula (1) may satisfy x=0.5. That is, the positive electrode active material 110 may include LiNi_{0.5}Mn_{1.5}O₄.

Lithium nickel manganese oxide is a positive electrode active material that can achieve a high operating voltage. However, lithium nickel manganese oxide is likely to cause oxidation of another material such as an electrolyte. According to the present embodiment, the surface of the positive electrode active material 110 including lithium nickel manganese oxide is coated with the first solid electrolyte material 111. This makes it possible to suppress oxidative decomposition of another electrolyte material during charge of a battery. Consequently, the energy density and the charge and discharge efficiency of a battery including the positive electrode material 1000 can be enhanced. A decrease in the charge and discharge capacity of such a battery can also suppressed. The effect achieved by application of the technique of the present disclosure to lithium nickel manganese oxide is particularly high. Furthermore, the material represented by the composition formula (1) is free of Co, and is thus inexpensive. With the above configuration, it is possible to provide the positive electrode material 1000 that can enhance the charge and discharge efficiency of a battery and is available at low cost.

The positive electrode active material 110 may consist only of LiNi_{0.5}Mn_{1.5}O₄. Herein, being “consisting only of” a component means that no other components except the component and inevitable impurities are intentionally added.

With the above configuration, a decrease in the charge and discharge capacity of a battery is reduced.

The first solid electrolyte material 111 may include a material represented by the following composition formula (2):

LiPF_{y}O_{3-0.5y} Formula (2),
where y satisfies 0<y<6.

In the composition formula (2), y=2 may be satisfied. When y=2 is satisfied, the material represented by the formula (2) is lithium difluorophosphate. Since lithium difluorophosphate has lithium-ion conductivity and an excellent oxidation resistance, lithium difluorophosphate is suitable for the first solid electrolyte material.

The first solid electrolyte material 111 may be an electrolyte material including Li, P, O, and F. The first solid electrolyte material 111 may be at least one selected from the group consisting of LiPOF₄, LiPO₂F₂, and Li₂PO₃F.

The first solid electrolyte material 111 may include lithium difluorophosphate as the main component. Here, the term “main component” refers to a component having the highest content on a mass ratio basis.

The first solid electrolyte material 111 may consist only of lithium difluorophosphate.

With such a configuration, the first solid electrolyte material 111 has ionic conductivity and an excellent oxidation resistance. Therefore, in the positive electrode material 1000, oxidative decomposition of the first solid electrolyte material 111 can be suppressed and the ionic conductivity of the first solid electrolyte material 111 can be ensured.

A percentage of a mass of the first solid electrolyte material 111 with respect to a mass of the positive electrode active material 110 may be 0.50% or more. The percentage of the mass of the first solid electrolyte material 111 with respect to the mass of the positive electrode active material 110 may be 0.60% or more, 0.70% or more, or 0.80% or more.

The percentage of the mass of the first solid electrolyte material 111 with respect to the mass of the positive electrode active material 110 may be determined, for example, by dissolving the positive electrode material in an acid or the like and quantifying elements in the resulting aqueous solution by inductively coupled plasma (ICP) optical emission spectroscopy. Here, the percentage of the mass of the first solid electrolyte material 111 with respect to the mass of the positive electrode active material 110 may be determined from a quantitative value of an element included only in the positive electrode active material 110 and a quantitative value of an element included only in the first solid electrolyte material 111 assuming that the positive electrode active material 110 and the first solid electrolyte material 111 are stoichiometric compositions. For example, when LiNi_{0.5}Mn_{1.5}O₄ is coated with LiPO₂F₂, the percentage of the mass of the first solid electrolyte material 111 with respect to the mass of the positive electrode active material 110 may be determined from quantitative values of Ni and P assuming that the LiNi_{0.5}Mn_{1.5}O₄ and the LiPO₂F₂ are present as stoichiometric compositions.

The percentage of the mass of the first solid electrolyte material 111 with respect to the mass of the positive electrode active material 110 may be 1.5% or more.

The percentage of the mass of the first solid electrolyte material 111 with respect to the mass of the positive electrode active material 110 may be 10.0% or less, or 7.0% or less.

The percentage of the mass of the first solid electrolyte material 111 with respect to the mass of the positive electrode active material 110 may be 0.50% or more and 10.0% or less, or 0.50% or more and 7.0% or less. The percentage of the mass of the first solid electrolyte material 111 with respect to the mass of the positive electrode active material 110 may be 2.50% or more and 10.0% or less, or 2.50% or more and 7.0% or less.

The upper and lower limits of the percentage of the mass of the first solid electrolyte material 111 with respect to the mass of the positive electrode active material 110 can be defined as any combination of numerical values selected from 1.5, 3.0, and 4.5.

The above effect can be sufficiently achieved by appropriately adjusting the percentage of the mass of the first solid electrolyte material 111 with respect to the mass of the positive electrode active material 110.

FIG. 2 is another cross-sectional view schematically showing the configuration of the positive electrode material 1000. As shown in FIG. 2, the positive electrode material 1000 may further include a second electrolyte material 100 having a composition different from a composition of the first solid electrolyte material 111. The second electrolyte material 100 has, for example, lithium-ion conductivity. According to the present embodiment, oxidative decomposition of the second electrolyte material 100 is suppressed, and thereby a decrease in the charge and discharge capacity of a battery including the positive electrode material 1000 can be suppressed.

The second electrolyte material 100 may include Li, a halogen element, and at least one selected from the group consisting of metalloid elements and metal elements except Li. The halogen element is F, Cl, Br, or I. Since the second electrolyte material 100 includes the halogen element, the second electrolyte material 100 has a relatively high oxidation resistance. Therefore, the second electrolyte material 100 is suitable for being used in combination with the positive electrode active material 110, such as lithium nickel manganese oxide, having a high potential.

The second electrolyte material 100 may include a material represented by the following composition formula (3):

Li_{α}M_{β}X_{γ}O_{δ} Formula (3),
where α, β, and γ are each a value greater than 0, δ is a value equal to or greater than 0, M includes at least one selected from the group consisting of metalloid elements and metal elements except Li, and X is at least one element selected from the group consisting of F, Cl, Br, and I.

The metalloid elements refer to B, Si, Ge, As, Sb, and Te.

The metal elements refer to all the elements included in Groups 1 to 12 of the periodic table except hydrogen and all the elements included in Groups 13 to 16 except B, Si, Ge, As, Sb, Te, C, N, P, O, S, and Se. That is, the metal elements are a group of elements that can become a cation when forming an inorganic compound with a halogen compound.

With the above configuration, the ionic conductivity of the second electrolyte material 100 can be further enhanced. That makes it possible to further reduce resistance resulting from migration of Li ions in the positive electrode material 1000.

In the composition formula (3), M may include at least one selected from the group consisting of Y and Ta. That is, the second electrolyte material 100 may include at least one selected from the group consisting of Y and Ta as a metal element.

With the above configuration, the ionic conductivity of the second electrolyte material 100 can be further enhanced. That makes it possible to further reduce resistance resulting from migration of Li ions in the positive electrode material 1000.

The composition formula (3) may satisfy 1<α≤4, 0<β≤2, 3≤γ<7, and 0≤δ≤2.

With the above configuration, the ionic conductivity of the second electrolyte material 100 can be further enhanced. That makes it possible to further reduce resistance resulting from migration of Li ions in the positive electrode material 1000 and thus more effectively suppress an increase in the internal resistance of a battery during charge.

The composition formula (3) may satisfy 2.5≤α≤3, 1≤β≤1.1, γ=6, and δ=0.

The second electrolyte material 100 including Y may be, for example, a compound represented by a composition formula LiₐMe_{b}Y_{c}X₆. Here, a+m′b+3c=6 and c>0 are satisfied. Me is at least one element selected from the group consisting of metalloid elements and metal elements except Li and Y. Furthermore, m′ represents the valence of Me.

Me may be at least one element selected from the group consisting of Mg, Ca, Sr, Ba, Zn, Sc, Al, Ga, Bi, Zr, Hf, Ti, Sn, Ta, and Nb.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A1).

Li_{6-3d}Y_{d}X₆ Formula (A1)

In the composition formula (A1), X is a halogen element and includes Cl. Furthermore, the composition formula (A1) satisfies 0<d<2.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A2).

Li₃YX₆ Formula (A2)

In the composition formula (A2), X is a halogen element and includes Cl.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A3).

Li_{3-3δ}Y_{1+δ}Cl₆ Formula (A3)

The composition formula (A3) satisfies 0<6 5 0.15.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A4).

Li_{3-3δ+a4}Y_{1+δ-a4}Meₐ₄Cl₆₋ₓ₄Brₓ₄ Formula (A4)

In the composition formula (A4), Me is at least one element selected from the group consisting of Mg, Ca, Sr, Ba, and Zn. Furthermore, the composition formula (A4) satisfies −1<δ<2, 0<a4<3, 0<(3−3δ+a4), 0<(1+δ−a4), and 0≤x4<6.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A5).

Li_{3-3δ}Y_{1+δ-a5}Meₐ₅Cl₆₋ₓ₅Brₓ₅ Formula (A5)

In the composition formula (A5), Me is at least one element selected from the group consisting of Al, Sc, Ga, and Bi. Furthermore, the composition formula (A5) satisfies −1<δ<1, 0<a5<2, 0<(1+δ−a5), and 0≤x5<6.

With the above configuration, the ionic conductivity of the second electrolyte material 100 can be further enhanced. That makes it possible to further reduce resistance resulting from migration of Li ions in the positive electrode material 1000.

The second electrolyte material 100 may be a material represented by the following composition formula (A6).

Li_{3-3δ-a6}Y_{1+δ-a6}Meₐ₆Cl₆₋ₓ₆Brₓ₆ Formula (A6)

In the composition formula (A6), Me is at least one element selected from the group consisting of Zr, Hf, and Ti. Furthermore, the composition formula (A6) satisfies −1<δ<1, 0<a6<1.5, 0<(3−3δ−a6), 0<(1+δ−a6), and 0≤x6<6.

The second electrolyte material 100 may be a material represented by the following composition formula (A7).

Li_{3-3δ-2a7}Y_{1+δ-a7}Meₐ₇Cl₆₋ₓ₇Brₓ₇ Formula (A7)

In the composition formula (A7), Me is at least one element selected from the group consisting of Ta and Nb. Furthermore, the composition formula (A7) satisfies −1<δ<1, 0<a7<1.2, 0<(3−3δ−2a7), 0<(1+δ−a7), and 0≤x7<6.

The second electrolyte material 100 can be, for example, Li₃YX₆, Li₂MgX₄, Li₂FeX₄, Li(Al,Ga,In)X₄, or Li₃(Al,Ga,In)X₆. Here, X includes Cl. Note that, in the present disclosure, when an element in a formula is expressed by, for example, “(Al,Ga,In)”, this expression indicates at least one element selected from the group of elements in parentheses. That is, “(Al,Ga,In)” is synonymous with “at least one selected from the group consisting of Al, Ga, and In”. The same applies to other elements.

As the second electrolyte material 100, a sulfide solid electrolyte may be included. The sulfide solid electrolyte can be, for example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or Li₆PS₅Cl. Furthermore, LiX, Li₂O, MO_{q}, LiₚMO_{q}, or the like may be added to these. Here, X is at least one element selected from the group consisting of F, Cl, Br, and I. M is at least one element selected from the group consisting of P, Si, Ge, B, Al, Ga, In, Fe, and Zn. The symbols p and q are each independently a natural number.

The second electrolyte material 100 may include lithium sulfide and phosphorus sulfide. For example, the sulfide solid electrolyte may be Li₂S—P₂S₅. The sulfide solid electrolyte may be at least one selected from the group consisting of Li₂S—P₂S₅ and Li₆PS₅Cl.

The ionic conductivity of the second electrolyte material 100 can be further enhanced by using the sulfide solid electrolyte as the second electrolyte material 100. That makes it possible to further reduce resistance resulting from migration of Li ions in the positive electrode material 1000 and thus more effectively suppress an increase in the internal resistance of a battery during charge.

The second electrolyte material 100 may be a solid electrolyte material.

The second electrolyte material 100 may include an electrolyte solution.

The electrolyte solution contains a solvent and a lithium salt dissolved in the solvent.

Examples of the solvent include water and a non-aqueous solvent. Examples of the non-aqueous solvent include a cyclic carbonate solvent, a chain carbonate solvent, a cyclic ether solvent, a chain ether solvent, a cyclic ester solvent, a chain ester solvent, and a fluorinated solvent.

Examples of the cyclic carbonate solvent include ethylene carbonate, propylene carbonate, and butylene carbonate.

Examples of the chain carbonate solvent include dimethyl carbonate, ethyl methyl carbonate, and diethyl carbonate.

Examples of the cyclic ether solvent include tetrahydrofuran, 1,4-dioxane, and 1,3-dioxolane.

Examples of the chain ether solvent include 1,2-dimethoxyethane and 1,2-diethoxyethane.

Examples of the cyclic ester solvent include γ-butyrolactone.

Examples of the chain ester solvent include methyl acetate.

Examples of the fluorinated solvent include fluoroethylene carbonate, methyl fluoropropionate, fluorobenzene, fluoroethyl methyl carbonate, and fluorodimethylene carbonate.

As the solvent, one solvent selected from these can be used alone, or alternatively, a combination of two or more solvents selected from these can be used.

The electrolyte solution may contain at least one fluorinated solvent selected from the group consisting of fluoroethylene carbonate, methyl fluoropropionate, fluorobenzene, fluoroethyl methyl carbonate, and fluorodimethylene carbonate.

The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. As the lithium salt, one lithium salt selected from these can be used alone, or alternatively, a mixture of two or more lithium salts selected from these can be used. The lithium salt concentration is, for example, in a range of 0.1 mol/L to 15 mol/L.

The positive electrode material 1000 may further include a positive electrode active material other than the positive electrode active material 110 consisting of Li, N, Mn, and O.

The positive electrode active material includes a material having properties of occluding and releasing metal ions (e.g., lithium ions). The positive electrode active material other than the positive electrode active material 110 can be, for example, a lithium-including transition metal oxide, a transition metal fluoride, a polyanion material, a fluorinated polyanion material, a transition metal sulfide, a transition metal oxysulfide, or a transition metal oxynitride. Examples of the lithium-including transition metal oxide include Li(Ni,Co,Al)O₂, Li(Ni,Co,Mn)O₂, and LiCoO₂. In particular, in the case where the lithium-including transition metal oxide is used, it is possible to reduce the manufacturing cost of the positive electrode material 1000, and to enhance the average discharge voltage.

The first solid electrolyte material 111 may be provided between the positive electrode active material 110 and the second electrolyte material 100.

With the above configuration, since the first solid electrolyte material 111 having a high oxidation resistance is interposed between the positive electrode active material 110 and the second electrolyte material 100, oxidative decomposition of the second electrolyte material 100 can be suppressed. Therefore, it is possible to suppress an increase in the internal resistance of a battery during charge.

The first solid electrolyte material 111 coating at least a portion of the surface of the positive electrode active material 110 may have a thickness of 1 nm or more and 500 nm or less.

In the case where the first solid electrolyte material 111 has a thickness of 1 nm or more, a direct contact between the positive electrode active material 110 and the second electrolyte material 100 can be reduced, and thus oxidative decomposition of the second electrolyte material 100 can be suppressed. Consequently, it is possible to enhance the charge and discharge efficiency of a battery including the positive electrode material 1000. In the case where the first solid electrolyte material 111 has a thickness of 500 nm or less, the first solid electrolyte material 111 is not excessively large in thickness. Consequently, it is possible to sufficiently reduce the internal resistance of a battery including the positive electrode material 1000 and thus enhance the energy density of the battery.

The method for measuring the thickness of the first solid electrolyte material 111 is not particularly limited. For example, a transmission electron microscope can be used to directly observe the first solid electrolyte material 111 and thus to determine the thickness.

The percentage of the mass of the first solid electrolyte material 111 with respect to the mass of the positive electrode active material 110 may be 0.01% or more and 30% or less.

In the case where the percentage of the mass of the first solid electrolyte material 111 with respect to the mass of the positive electrode active material 110 is 0.01% or more, a direct contact between the positive electrode active material 110 and the second electrolyte material 100 can be reduced, and thus oxidative decomposition of the second electrolyte material 100 can be suppressed. Consequently, it is possible to suppress an increase in the internal resistance of a battery during charge. In the case where the percentage of the mass of the first solid electrolyte material 111 with respect to the mass of the positive electrode active material 110 is 30% or less, the thickness of the first solid electrolyte material 111 is not excessively large. Consequently, it is possible to sufficiently reduce the internal resistance of a battery including the positive electrode material 1000 and thus enhance the energy density of the battery.

The first solid electrolyte material 111 may coat uniformly the surface of the positive electrode active material 110. In this case, a direct contact between the positive electrode active material 110 and the second electrolyte material 100 can be reduced, and thus a side reaction of the second electrolyte material 100 can be suppressed. Therefore, it is possible to further enhance the charge and discharge characteristics of a battery including the positive electrode material 1000 and to suppress a decrease in the capacity thereof.

The first solid electrolyte material 111 may coat a portion of the surface of the positive electrode active material 110. In this case, a plurality of the positive electrode active materials 110 are in direct contact with each other at their portions uncoated with the first solid electrolyte material 111. Consequently, the electronic conductivity between the plurality of positive electrode active materials 110 is enhanced. That enables a battery including the positive electrode material 1000 to operate at a high power.

The first solid electrolyte material 111 may coat 30% or more, 60% or more, or 90% or more of the surface of the positive electrode active material 110. The first solid electrolyte material 111 may coat substantially the entire surface of the positive electrode active material 110.

The first solid electrolyte material 111 may be in direct contact with the surface of the positive electrode active material 110.

At least a portion of the surface of the positive electrode active material 110 may be coated with a coating material having a composition different from the composition of the first solid electrolyte material 111.

Examples of the coating material include a sulfide solid electrolyte, an oxide solid electrolyte, and a halide solid electrolyte. The materials of the sulfide solid electrolyte, the oxide solid electrolyte, and the halide solid electrolyte used as the coating material may be the same materials as those exemplified for the second electrolyte material 100. The oxide solid electrolyte used as the coating material is, for example, a Li—B—O compound, such as LiBO₂ or Li₃BO₃, a Li-AI-O compound, such as LiAlO₂, a Li—Si—O compound, such as Li₄SiO₄, a Li—Ti—O compound, such as Li₂SO₄ or Li₄Ti₅O₁₂, a Li—Zr—O compound, such as Li₂ZrO₃, a Li—Mo—O compound, such as Li₂MoO₃, a Li-V-O compound, such as LiV₂O₅, a Li—W—O compound, such as Li₂WO₄, or a Li—P—O compound, such as Li₃PO₄. The halide solid electrolyte used as the coating material is, for example, a solid electrolyte including Li, Ti, M1, and F, where M1 is at least one element selected from the group consisting of Ca, Mg, Al, Y, and Zr.

With the above configuration, oxidative decomposition of the second electrolyte material 100 can be suppressed. Consequently, an increase in the internal resistance of a battery during charge can be suppressed.

The positive electrode active material 110 and the first solid electrolyte material 111 may be separated from each other by the coating material so as not to be in direct contact with each other.

With the above configuration, oxidative decomposition of the second electrolyte material 100 can be suppressed. Consequently, an increase in the internal resistance of a battery during charge can be suppressed.

The shape of the second electrolyte material 100 is not particularly limited. In the case where the second electrolyte material 100 is a powdery material, its shape may be, for example, an acicular, spherical, or ellipsoidal shape. The second electrolyte material 100 may be, for example, particulate.

For example, in the case where the second electrolyte material 100 is particulate (e.g., spherical), the second electrolyte material 100 may have a median diameter of 100 μm or less. In the case where the second electrolyte material 100 has a median diameter of 100 μm or less, the positive electrode active material 110 and the second electrolyte material 100 can be in a favorable dispersion state in the positive electrode material 1000. This enhances the charge and discharge characteristics of a battery including the positive electrode material 1000.

The second electrolyte material 100 may have a median diameter of 10 μm or less. With the above configuration, the positive electrode active material 110 and the second electrolyte material 100 can be in a favorable dispersion state in the positive electrode material 1000.

In Embodiment 1, the second electrolyte material 100 may have a smaller median diameter than that of the positive electrode active material 110. With the above configuration, the second electrolyte material 100 and the positive electrode active material 110 can be in a more favorable dispersion state in a positive electrode.

The positive electrode active material 110 may have a median diameter of 0.1 μm or more and 100 μm or less.

In the case where the positive electrode active material 110 has a median diameter of 0.1 μm or more, the positive electrode active material 110 and the second electrolyte material 100 can be in a favorable dispersion state in the positive electrode material 1000. This enhances the charge and discharge characteristics of a battery including the positive electrode material 1000. In the case where the positive electrode active material 110 has a median diameter of 100 μm or less, the diffusion rate of lithium in the positive electrode active material 110 is enhanced. This enables a battery including the positive electrode material 1000 to operate at a high power.

In the present disclosure, the term “median diameter” means the particle diameter at a cumulative volume equal to 50% in a volumetric particle size distribution. The volumetric particle size distribution is measured, for example, with a laser diffraction analyzer or an image analyzer.

In the positive electrode material 1000, the second electrolyte material 100 and the first solid electrolyte material 111 may be in contact with each other as shown in FIG. 2. In this case, the first solid electrolyte material 111 and the positive electrode active material 110 may be in contact with each other.

The positive electrode material 1000 may include two or more types of the second electrolyte material 100 and two or more types of the positive electrode active material 110.

In the positive electrode material 1000, the amount of the second electrolyte material 100 and the amount of the positive electrode active material 110 may be the same, or may be different from each other.

<Method for Manufacturing Positive Electrode Material 1000>

The positive electrode material 1000 of Embodiment 1 can be manufactured, for example, by the following method.

First, a solution containing the first solid electrolyte material 111 and a solvent is prepared. The solvent is not limited to a particular solvent as long as the solvent can dissolve the first solid electrolyte material 111. Examples of the solvent include 1,2-dimethoxyethane.

Next, the solution prepared as described above and the positive electrode active material 110 are mixed together to produce a mixture. The solvent is removed from the mixture to coat the positive electrode active material 110 with the first solid electrolyte material 111. The method for removing the solvent from the mixture is not limited to a particular method. The solvent may be removed from the mixture, for example, by reduced-pressure drying. The reduced-pressure drying means to remove the solvent from the mixture in an atmosphere having a pressure lower than the atmospheric pressure. The atmosphere having a pressure lower than the atmospheric pressure is, for example, an atmosphere having a pressure of 0.05 MPa or lower in gauge pressure.

The reduced-pressure drying may be vacuum drying. The vacuum drying means to remove the solvent, for example, at a temperature lower than the boiling point of the solvent and in an atmosphere having a pressure equal to or lower than a vapor pressure.

The second electrolyte material 100 can be manufactured by the following method.

In an example, to synthesize the second electrolyte material 100 consisting of Li, Ta, O, and Cl, raw material powders Li₂O₂ and TaCl₅ are mixed together and then fired. The raw material powders may be mixed together in a molar ratio adjusted in advance so as to cancel out a composition change which can occur in the synthesis process. Thus, the second electrolyte material 100 is obtained.

The positive electrode material 1000 of Embodiment 1 can be manufactured by mixing the second electrolyte material 100 and the positive electrode active material 110 having a surface coated with the first solid electrolyte material 111.

### Embodiment 2

Embodiment 2 will be described below. The description overlapping with that of Embodiment 1 will be omitted as appropriate.

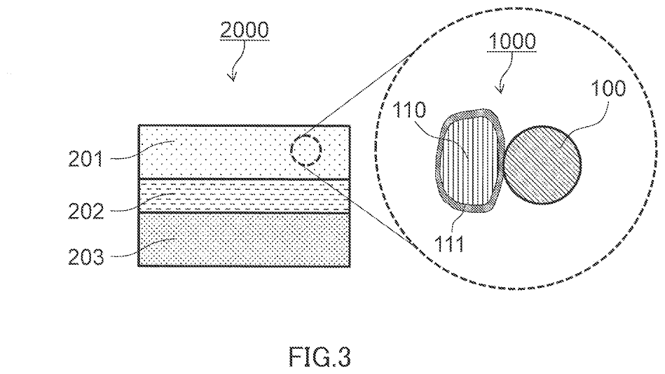

FIG. 3 is a cross-sectional view schematically showing the configuration of a battery 2000 of Embodiment 2.

The battery 2000 of Embodiment 2 includes a positive electrode 201, an electrolyte layer 202, and a negative electrode 203. The positive electrode 201 includes the positive electrode material 1000 of Embodiment 1. The electrolyte layer 202 is disposed between the positive electrode 201 and the negative electrode 203.

With the above configuration, an increase in the internal resistance of the battery 2000 during charge can be suppressed, and thus a decrease in the charge and discharge capacity can be suppressed.

A volume ratio “v1:100-v1” between the positive electrode material 1000 and the second electrolyte material 100 included in the positive electrode 201 may satisfy 30≤v1≤98. Here, v1 represents a volume ratio of the positive electrode material 1000 to the total volume, expressed as 100, of the positive electrode material 1000 and the second electrolyte material 100 included in the positive electrode 201. In the case where 30≤v1 is satisfied, a sufficient energy density of the battery can be achieved. In the case where v1≤98 is satisfied, the battery 2000 can operate at a high power.

The positive electrode 201 may have a thickness of 10 μm or more and 500 μm or less. In the case where the positive electrode 201 has a thickness of 10 μm or more, a sufficient energy density of the battery can be achieved. In the case where the positive electrode 201 has a thickness of 500 μm or less, the battery 2000 can operate at a high power.

The electrolyte layer 202 includes an electrolyte material. The electrolyte material may be, for example, a third solid electrolyte material. That is, the electrolyte layer 202 may be a solid electrolyte layer.

The third solid electrolyte material may be a material that is the same as the first solid electrolyte material 111 of Embodiment 1 or the same as the second electrolyte material 100 of Embodiment 1. That is, the electrolyte layer 202 may include a material that is the same as the first solid electrolyte material 111 of Embodiment 1 or the same as the second electrolyte material 100 of Embodiment 1.

With the above configuration, the output density and the charge and discharge characteristics of the battery 2000 can be further enhanced.

The third solid electrolyte material may be the same material as the first solid electrolyte material 111 of Embodiment 1. That is, the electrolyte layer 202 may include the same material as the same material as the first solid electrolyte material 111 of Embodiment 1.

With the above configuration, an increase in the internal resistance of the battery 2000 caused by oxidation of the electrolyte layer 202 can be suppressed, and thus the output density and the charge and discharge characteristics of the battery 2000 can be further enhanced.

The third solid electrolyte material included in the electrolyte layer 202 may be a halide solid electrolyte, a sulfide solid electrolyte, an oxide solid electrolyte, a polymer solid electrolyte, or a complex hydride solid electrolyte.

The oxide solid electrolyte being the third solid electrolyte material can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or a glass or glass ceramic that includes a Li—B—O compound, such as LiBO₂ or Li₃BO₃, as a base, and to which Li₂SO₄, Li₂CO₃, or the like is added.

The polymer solid electrolyte being the third solid electrolyte material can be, for example, a compound of a polymer compound and a lithium salt. The polymer compound may have an ethylene oxide structure. The polymer compound having an ethylene oxide structure can contain a large amount of a lithium salt. Consequently, the ionic conductivity can be further enhanced. The lithium salt can be LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like. One lithium salt selected from the examples of the lithium salt can be used alone. Alternatively, a mixture of two or more lithium salts selected from the examples of the lithium salt can be used.

The complex hydride solid electrolyte being the third solid electrolyte material can be, for example, LiBH₄—LiI or LiBH₄—P₂S₅.

The electrolyte layer 202 may include the third solid electrolyte material as the main component. That is, the electrolyte layer 202 may include the third solid electrolyte material, for example, such that the mass ratio of the third solid electrolyte material to the entire electrolyte layer 202 is 50% or more (i.e., 50 mass % or more).

With the above configuration, the charge and discharge characteristics of the battery can be further enhanced.

The electrolyte layer 202 may include the third solid electrolyte material, for example, such that the mass ratio of the third solid electrolyte material to the entire electrolyte layer 202 is 70% or more (i.e., 70 mass % or more).

With the above configuration, the charge and discharge characteristics of the battery 2000 can be further enhanced.

The electrolyte layer 202 may include the third solid electrolyte material as the main component and further include inevitable impurities, or a starting material used for synthesis of the third solid electrolyte material, a by-product, a decomposition product, and the like.

The electrolyte layer 202 may include the third solid electrolyte material, for example, such that the mass ratio of the third solid electrolyte material to the entire electrolyte layer 202 is 100% (i.e., 100 mass %), except for inevitably incorporated impurities.

With the above configuration, the charge and discharge characteristics of the battery 2000 can be further enhanced.

The electrolyte layer 202 may consist only of the third solid electrolyte material.

The electrolyte layer 202 may include two or more of the materials listed as the third solid electrolyte material. For example, the electrolyte layer 202 may include a halide solid electrolyte and a sulfide solid electrolyte.

The electrolyte layer 202 may have a thickness of 1 μm or more and 300 μm or less. In the case where the electrolyte layer 202 has a thickness of 1 μm or more, a short circuit between the positive electrode 201 and the negative electrode 203 tends not to occur. In the case where the electrolyte layer 202 has a thickness of 300 μm or less, the battery 2000 can operate at a high power.

The negative electrode 203 includes a material having properties of occluding and releasing metal ions (e.g., lithium ions). The negative electrode 203 includes, for example, a negative electrode active material.

The negative electrode active material can be a metal material, a carbon material, an oxide, a nitride, a tin compound, a silicon compound, or the like. The metal material may be a simple substance of metal. Alternatively, the metal material may be an alloy. Examples of the metal material include lithium metal and a lithium alloy. Examples of the carbon material include natural graphite, coke, semi-graphitized carbon, a carbon fiber, spherical carbon, artificial graphite, and amorphous carbon. From the viewpoint of capacity density, silicon, tin, a silicon compound, or a tin compound can be used.

The negative electrode 203 may include a solid electrolyte material. As the solid electrolyte material, the solid electrolyte materials exemplified as the materials of the electrolyte layer 202 may be used. With the above configuration, the lithium-ion conductivity inside the negative electrode 203 can be enhanced, and consequently the battery 2000 can operate at a high power.

The negative electrode active material may have a median diameter of 0.1 μm or more and 100 μm or less. In the case where the negative electrode active material has a median diameter of 0.1 μm or more, the negative electrode active material and the solid electrolyte material can be in a favorable dispersion state in the negative electrode. This enhances the charge and discharge characteristics of the battery 2000. In the case where the negative electrode active material has a median diameter of 100 μm or less, the speed of diffusion of lithium in the negative electrode active material is enhanced. This enables the battery 2000 to operate at a high power.

The negative electrode active material may have a larger median diameter than that of the solid electrolyte material included in the negative electrode 203. In this case, the negative electrode active material and the solid electrolyte material can be in a favorable dispersion state.

A volume ratio “v2:100-v2” between the negative electrode active material and the solid electrolyte material included in the negative electrode 203 may satisfy 30≤v2≤95. Here, v2 represents a volume ratio of the negative electrode active material to the total volume, expressed as 100, of the negative electrode active material and the solid electrolyte material included in the negative electrode 203. In the case where 30≤v2 is satisfied, a sufficient energy density of the battery can be achieved. In the case where v2≤95 is satisfied, the battery 2000 can operate at a high power.

The negative electrode 203 may have a thickness of 10 μm or more and 500 μm or less. In the case where the negative electrode 203 has a thickness of 10 μm or more, a sufficient energy density of the battery 2000 can be achieved. In the case where the negative electrode 203 has a thickness of 500 μm or less, the battery 2000 can operate at a high power.

At least one selected from the group consisting of the positive electrode 201, the electrolyte layer 202, and the negative electrode 203 may include a binder for the purpose of enhancing the adhesion between the particles. The binder is used to enhance the binding properties of the materials of the electrodes. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, as the binder can also be used a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from these may be used.

At least one selected from the group consisting of the positive electrode 201 and the negative electrode 203 may include a conductive additive for the purpose of enhancing the electronic conductivity. The conductive additive can be, for example: graphite, such as natural graphite or artificial graphite; carbon black, such as acetylene black or Ketjenblack; a conductive fiber, such as a carbon fiber or a metal fiber; carbon fluoride; a metal powder, such as an aluminum powder; a conductive whisker, such as a zinc oxide whisker or a potassium titanate whisker; a conductive metal oxide, such as titanium oxide; or a conductive polymer compound, such as polyaniline, polypyrrole, or polythiophene. Using a conductive carbon additive as the conductive additive can seek cost reduction for the battery 2000.

The shape of the battery 2000 of Embodiment 2 is, for example, a coin type, a cylindrical type, a prismatic type, a sheet type, a button type, a flat type, or a stack type.

The battery 2000 may be manufactured, for example, by preparing the positive electrode material 1000, the material(s) of the electrolyte layer, and the material(s) of the negative electrode and producing by a known method a stack in which the positive electrode, the electrolyte layer, and the negative electrode are disposed in this order.

### Embodiment 3

Embodiment 3 will be described below. The description overlapping with those of Embodiments 1 and 2 will be omitted as appropriate.

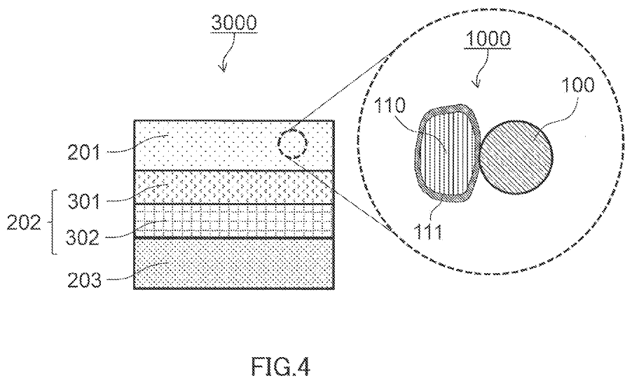

FIG. 4 is a cross-sectional view schematically showing the configuration of a battery 3000 of Embodiment 3.

The battery 3000 of Embodiment 3 includes the positive electrode 201, the electrolyte layer 202, and the negative electrode 203. The positive electrode 201 includes the positive electrode material 1000 of Embodiment 1. The electrolyte layer 202 is disposed between the positive electrode 201 and the negative electrode 203. The electrolyte layer 202 includes a first electrolyte layer 301 and a second electrolyte layer 302. The first electrolyte layer 301 is positioned between the positive electrode 201 and the second electrolyte layer 302 and is in contact with the positive electrode 201. The second electrolyte layer 302 is positioned between the first electrolyte layer 301 and the negative electrode 203 and is in contact with the negative electrode 203.

According to the above configuration, an electrolyte having a high oxidation resistance can be used as the material of the first electrolyte layer 301, and an electrolyte having a high reduction resistance can be used as the material of the second electrolyte layer 302. The second electrolyte layer 302 is separated from the positive electrode 201 by the first electrolyte layer 301. Because of this, oxidative decomposition of the electrolyte included in the second electrolyte layer 302 can be suppressed. The first electrolyte layer 301 is separated from the negative electrode 203 by the second electrolyte layer 302. Because of this, reduction decomposition of the electrolyte included in the first electrolyte layer 301 can be suppressed.

The first electrolyte layer 301 may include a material having the same composition as the composition of the first solid electrolyte material 111.

In the case where the first electrolyte layer 301 in contact with the positive electrode 201 includes a material having the same composition as the composition of the first solid electrolyte material 111 having an excellent oxidation resistance, oxidative decomposition of the first electrolyte layer 301 can be suppressed, and thus an increase in the internal resistance of the battery 3000 during charge can be suppressed.

The second electrolyte layer 302 may include a material having a composition different from the composition of the first solid electrolyte material 111.

The second electrolyte layer 302 may include a material having the same composition as the composition of the second electrolyte material 100.

From the viewpoint of the reduction resistance of solid electrolyte materials, the reduction potential of the solid electrolyte material included in the second electrolyte layer 302 may be lower than the reduction potential of the solid electrolyte material included in the first electrolyte layer 301. With the above configuration, the solid electrolyte material included in the first electrolyte layer 301 can be used without being reduced. Consequently, the charge and discharge efficiency of the battery 3000 can be enhanced.

For example, when the first electrolyte layer 301 includes the first solid electrolyte material 111, the second electrolyte layer 302 may include a sulfide solid electrolyte to suppress reduction decomposition of the first solid electrolyte material 111. The first solid electrolyte material 111 is suitable as the material of the first electrolyte layer 301 because of its high oxidation resistance. The sulfide solid electrolyte is suitable as the material of the second electrolyte layer 302 because of its high reduction resistance. Decomposition of the electrolyte in the electrolyte layer 202 can be effectively suppressed by using materials respectively suitable for the first electrolyte layer 301 and the second electrolyte layer 302. Consequently, the charge and discharge efficiency of the battery 3000 can be enhanced.

The first electrolyte layer 301 and the second electrolyte layer 302 each may have a thickness of 1 μm or more and 300 μm or less. In the case where the first electrolyte layer 301 and the second electrolyte layer 302 each have a thickness of 1 μm or more, a short circuit between the positive electrode 201 and the negative electrode 203 tends not to occur. In the case where the first electrolyte layer 301 and the second electrolyte layer 302 each have a thickness of 300 μm or less, the battery 3000 can operate at a high power.

### EXAMPLES

The present disclosure will be described below in more detail with reference to examples.

### Example 1

[Production of Positive Electrode Active Material Having Surface Coated with First Solid Electrolyte Material]

An amount of 0.030 g of LiPO₂F₂ was dissolved in 3 mL of 1,2-dimethoxyethane in an argon glove box to produce a coating solution.

The whole amount of the coating solution prepared as described above was added to and mixed with 2.00 g of a positive electrode active material LiNi_{0.5}Mn_{1.5}O₄, and then the 1,2-dimethoxyethane was evaporated. A coated positive electrode active material of Example 1 was thus obtained.

[Production of Second Electrolyte Material]

In a dry atmosphere with a dew point of −30° C. or lower, raw material powders Li₂O₂ and TaCl₅ were prepared in a molar ratio of 1.2:2. These raw material powders were pulverized and mixed together in a mortar to obtain a mixed powder. The obtained mixed powder was milled with a planetary ball mill at 600 rpm for 24 hours. Next, the mixed powder was fired at 200° C. for 6 hours. A second electrolyte material of Examples 1 to 3 and Reference Example 1 was thus obtained.

[Production of Positive Electrode Material]

The positive electrode active material of Example 1, the second electrolyte material, and vapor-grown carbon fibers (manufactured by SHOWA DENKO K.K.) as a conductive additive were weighed in a mass ratio of 73.1:25.9:1.0, and were mixed together in a mortar. Thus, a positive electrode material of Example 1 was produced. The percentage of the mass of the first solid electrolyte material with respect to the mass of the positive electrode active material in the positive electrode material of Example 1 is shown in Table 1.

### Example 2

[Production of Positive Electrode Active Material Having Surface Coated with First Solid Electrolyte Material]

An amount of 0.060 g of LiPO₂F₂ was dissolved in 3 mL of 1,2-dimethoxyethane in an argon glove box to produce a coating solution.

The whole amount of the coating solution prepared as described above was added to and mixed with 2.00 g of a positive electrode active material LiNi_{0.5}Mn_{1.5}O₄, and then the 1,2-dimethoxyethane was evaporated. A coated positive electrode active material of Example 2 was thus obtained.

[Production of Positive Electrode Material]

The positive electrode active material of Example 2, the second electrolyte material, and vapor-grown carbon fibers (manufactured by SHOWA DENKO K.K.) as a conductive additive were weighed in a mass ratio of 73.4:25.6:1.0, and were mixed together in a mortar. Thus, a positive electrode material of Example 2 was produced. The percentage of the mass of the first solid electrolyte material with respect to the mass of the positive electrode active material in the positive electrode material of Example 2 is shown in Table 1.

### Example 3

[Production of Positive Electrode Active Material Having Surface Coated with First Solid Electrolyte Material]

An amount of 0.090 g of LiPO₂F₂ was dissolved in 3 mL of 1,2-dimethoxyethane in an argon glove box to produce a coating solution.

The whole amount of the coating solution prepared as described above was added to and mixed with 2.00 g of a positive electrode active material LiNi_{0.5}Mn_{1.5}O₄, and then the 1,2-dimethoxyethane was evaporated. A coated positive electrode active material of Example 3 was thus obtained.

[Production of Positive Electrode Material]

The positive electrode active material of Example 3, the second electrolyte material, and vapor-grown carbon fibers (manufactured by SHOWA DENKO K.K.) as a conductive additive were weighed in a mass ratio of 73.6:25.4:1.0, and were mixed together in a mortar. Thus, a positive electrode material of Example 3 was produced. The percentage of the mass of the first solid electrolyte material with respect to the mass of the positive electrode active material in the positive electrode material of Example 3 is shown in Table 1.

### Example 4

A positive electrode material of Example 4 was produced in the same manner as in Example 1, except that Li₆PS₅Cl was used as the second electrolyte material. The percentage of the mass of the first solid electrolyte material with respect to the mass of the positive electrode active material in the positive electrode material of Example 4 is shown in Table 1.

### Reference Example 1

[Production of Positive Electrode Material]

The positive electrode active material LiNi_{0.5}Mn_{1.5}O₄, the second electrolyte material of Examples 1 to 3, and vapor-grown carbon fibers as a conductive additive were weighed in a mass ratio of 72.8:26.2:1.0, and were mixed together in a mortar. Thus, a positive electrode material of Reference Example 1 was produced.

### Reference Example 2

[Production of Positive Electrode Material]

The positive electrode active material LiNi_{0.5}Mn_{1.5}O₄, the second electrolyte material of Example 4, and vapor-grown carbon fibers as a conductive additive were weighed in a mass ratio of 72.8:26.2:1.0, and were mixed in a mortar. Thus, a positive electrode material of Reference Example 2 was produced.

[Production of Battery]

Batteries respectively including the positive electrode materials of Examples 1 to 4 and Reference Examples 1 and 2 described above were produced by the following steps.

### Example 1

First, 80 mg of Li₆PS₅Cl was put into an insulating outer cylinder and pressure-molded at a pressure of 2 MPa. Next, 20 mg of the second electrolyte material used for the positive electrode material of Example 1 was added thereto, and was pressure-molded at a pressure of 2 MPa. Furthermore, 9.7 mg of the positive electrode material of Example 1 was added to the insulating outer cylinder, and was pressure-molded at a pressure of 720 MPa. Thus, a stack composed of a positive electrode and a solid electrolyte layer was obtained.

Next, metal Li was placed on one side of the solid electrolyte layer that was in contact with the positive electrode on the opposite side. The metal Li used had a thickness of 200 μm. This was pressure-molded at a pressure of 2 MPa to produce a stack composed of a positive electrode, a solid electrolyte layer, and a negative electrode.

Next, stainless steel current collectors were disposed on the top and the bottom of the stack, and current collector leads were attached to the current collectors.

Finally, an insulating ferrule was used to isolate the inside of the insulating outer cylinder from the outside atmosphere and hermetically seal the insulating outer cylinder. Thus, a battery of Example 1 was produced.

### Examples 2 to 4 and Reference Examples 1 and 2

An amount of 80 mg of Li₆PS₅Cl was put into an insulating outer cylinder and pressure-molded at a pressure of 2 MPa. To such insulating outer cylinders were added the second electrolyte materials, each in an amount of 20 mg, used for the positive electrode materials of Examples 2 to 4 and Reference Examples 1 and 2. The contents were pressure-molded at a pressure of 2 MPa. Furthermore, the positive electrode materials of Examples 2 to 4 and Reference Examples 1 and 2 were added to the respective insulating outer cylinders such that the amount of LiNi_{0.5}Mn_{1.5}O₄ was 7 mg.

The contents were pressure-molded at a pressure of 720 MPa. Thus, stacks each composed of a positive electrode and a solid electrolyte layer were obtained. Batteries of Examples 2 to 4 and Reference Examples 1 and 2 were produced in the same manner as in Example 1 except the above.

[Charge and Discharge Test]

A charge and discharge test was performed on the batteries of Examples 1 to 4 and Reference Examples 1 and 2 described above under the following conditions.

The battery was disposed in a thermostatic chamber set at 25° C.

Constant-current charge was performed at a current value of 42 μA equivalent to 0.05 C rate (20-hour rate) relative to the theoretical capacity of each battery. The end-of-charge voltage was set to 5.0 V (vs. Li/Li⁺). Next, constant-current discharge was performed at a current value of 42 μA equivalent to 0.05 C rate (20-hour rate). The end-of-discharge voltage was set to 3.5 V (vs. Li/Li⁺).

The results of the charge and discharge test on the batteries of Examples 1 to 4 and Reference Examples 1 and 2 are shown in Table 1.

TABLE 1

| | Percentage of | | | | | |
|---|---|---|---|---|---|---|
| | mass of first | Second | Charge | Discharge | Average | Capacity ratio |
| | solid electrolyte | electrolyte | capacity | capacity | discharge | Coating/ |
| | material (%) | material | (mAh/g) | (mAh/g) | voltage (V) | Non-coating |
| Example 1 | 1.5 | Li—Ta—Cl—O | 62 | 54 | 4.16 | 2.2 |
| Example 2 | 3.0 | Li—Ta—Cl—O | 44 | 37 | 4.04 | 1.5 |
| Example 3 | 4.5 | Li—Ta—Cl—O | 63 | 54 | 4.11 | 2.3 |
| Example 4 | 1.5 | Li—P—S—Cl | 57 | 39 | 4.13 | 5.7 |
| Reference | — | Li—Ta—Cl—O | 31 | 24 | 4.07 | — |
| Example 1 | | | | | | |
| Reference | — | Li—P—S—Cl | 38 | 6.8 | 3.83 | — |
| Example 2 | | | | | | |

In Table 1, “Capacity ratio Coating/Non-coating” for Examples 1 to 3 represents the ratio of the discharge capacity of each of Examples 1 to 3 to the discharge capacity of Reference Example 1. For Example 4, “Capacity ratio Coating/Non-coating” represents the ratio of the discharge capacity of Example 4 to the discharge capacity of Reference Example 2.

As shown in Table 1, coating the surface of the positive electrode active material with the first solid electrolyte material enhances the charge and discharge capacity of the battery.

The present disclosure enhances the charge and discharge capacity of the battery.

### INDUSTRIAL APPLICABILITY

The battery of the present disclosure can be used as, for example, an all-solid-state lithium-ion secondary battery.

What is claimed is:

1. A positive electrode material comprising:
a positive electrode active material; and
a first solid electrolyte material coating at least a portion of a surface of the positive electrode active material, wherein
the positive electrode active material comprises a Li-including transition metal oxide, and
the first solid electrolyte material comprises Li, P, O, and F.

2. The positive electrode material according to claim 1, wherein a redox potential of the positive electrode active material versus lithium metal is 4 V or more.

3. The positive electrode material according to claim 1, wherein the positive electrode active material comprises a material represented by the following composition formula (1):
LiNiₓMn₂₋ₓO₄ Formula (1),
where x satisfies 0<x<2.

4. The positive electrode material according to claim 3, wherein the composition formula (1) satisfies 0<x<1.

5. The positive electrode material according to claim 4, wherein the composition formula (1) satisfies x=0.5.

6. The positive electrode material according to claim 5, wherein the first solid electrolyte material comprises a material represented by the following composition formula (2):
LiPF_{y}O_{3-0.5y} Formula (2),
where y satisfies 0<y<6.

7. The positive electrode material according to claim 6, wherein the composition formula (2) satisfies y=2.

8. The positive electrode material according to claim 1, wherein a percentage of a mass of the first solid electrolyte material with respect to a mass of the positive electrode active material is 0.50% or more.

9. The positive electrode material according to claim 8, wherein the percentage is 1.5% or more.

10. The positive electrode material according to claim 1, further comprising a second electrolyte material having lithium-ion conductivity.

11. The positive electrode material according to claim 10, wherein the second electrolyte material comprises Li, a halogen element, and at least one selected from the group consisting of metalloid elements and metal elements except Li.

12. The positive electrode material according to claim 10, wherein the second electrolyte material comprises a material represented by the following composition formula (3):
Li_{α}M_{β}X_{γ}O_{δ} Formula (3), where
α, β, and γ are each a value greater than 0,
δ is a value equal to or greater than 0,
M comprises at least one selected from the group consisting of metalloid elements and metal elements except Li, and
X is at least one element selected from the group consisting of F, Cl, Br, and I.

13. The positive electrode material according to claim 12, wherein the M comprises at least one selected from the group consisting of Y and Ta.

14. The positive electrode material according to claim 12, wherein the composition formula (3) satisfies 1≤α≤4, 0<β≤2, 3≤γ<7, and 0≤δ≤2.

15. The positive electrode material according to claim 10, wherein the second electrolyte material comprises a sulfide solid electrolyte.

16. The positive electrode material according to claim 15, wherein the sulfide solid electrolyte comprises Li₆PS₅Cl.

17. The positive electrode material according to claim 10, wherein the first solid electrolyte material is provided between the positive electrode active material and the second electrolyte material.

18. A battery comprising:
a positive electrode;
a negative electrode; and
an electrolyte layer positioned between the positive electrode and the negative electrode, wherein
the positive electrode comprises the positive electrode material according to claim 1.

19. The battery according to claim 18, wherein
the electrolyte layer comprises a first electrolyte layer and a second electrolyte layer,
the first electrolyte layer is in contact with the positive electrode, and
the second electrolyte layer is in contact with the negative electrode.

20. The battery according to claim 19, wherein the first electrolyte layer comprises a material having the same composition as a composition of the first solid electrolyte material.

21. The battery according to claim 19, wherein the second electrolyte layer comprises a material having a composition different from a composition of the first solid electrolyte material.
